(19) United States
(12) Patent Application Publication
(10) Pub. No.: US 2023/0166895 A1
(43) Pub. Date: Jun. 1, 2023

(54) Biodegradable Packaging Unit for a Food Product and Method for Manufacturing Such Packaging Unit

(71) Applicant: Huhtamaki Molded Fiber Technology B.V., Leeuwarden (NL)

(72) Inventor: Harald John Kuiper, Leeuwarden (NL)

(21) Appl. No.: 17/792,939

(22) PCT Filed: Jan. 14, 2021
(86) PCT No.: PCT/NL2021/050018

§ 371 Date: Jul. 14, 2022

(30) Foreign Application Priority Data
Jan. 17, 2020 (NL) 2024698
Mar. 30, 2020 (NL) 2025241

(51) Int. Cl. B65D 65/46; B65D 65/40

(52) U.S. Cl. CPC B65D 65/466; B65D 65/40; B65D 2213/00; B65D 2565/386

(57) ABSTRACT

The invention relates to a biodegradable packaging unit for a food product and a manufacturing method there for. The packaging unit comprises: —a container with an outer surface and an inner surface at least partly defining a compartment for holding the food product; —a biodegradable multi-layer that is provided on the inner surface of the container and comprising: —an inner cover layer comprising an amount of a biodegradable aliphatic polyester; —a first intermediate layer of a biodegradable material for connecting and/or sealing adjacent layers; —a functional layer comprising a polyvinylalcohol; —a second intermediate layer of a biodegradable material for connecting and/or sealing adjacent layers; and—an outer cover layer comprising an amount of a biodegradable aliphatic polyester, wherein the container comprises a moulded fiber matrix with an amount of biodegradable aliphatic polyester.

The present invention relates to a packaging unit for a food product. Such packaging unit is made from a moulded pulp material and is used to contain, store, transport and/or display a range of products, such as eggs, tomatoes, beverages etc. The packaging unit may relate to cases, cups, plates, carriers etc.

Packaging units are commonly used. One of the problems with conventional packaging units for food products is that the packaging units are often not sustainable, or at least not fully sustainable. Therefore, packaging units that are made from a moulded pulp material are known.

However, packaging units from a moulded pulp material may be used under unfavourable conditions, like high humidity, high pressure and/or high temperature. In practice, this reduces the performance of the packaging units, for example in relation to denesting properties. Also other properties can be negatively influenced by the unfavourable conditions. In addition, packaging units that come into contact with food products are subject to many restrictions. This often requires providing an additional film layer, with the film layer acting as a barrier. This barrier separates the food product from its environment. Furthermore, this use of an additional film layer also puts restrictions on the recycling possibilities.

The present invention has for its object to obviate or at least reduce one or more of the above stated problems in conventional food packaging units and to provide a packaging unit that is more sustainable and/or has improved recycling possibilities.

For this purpose, the present invention provides a biodegradable packaging unit for a food product, the packaging unit comprising:
a container with an outer surface and an inner surface at least partly defining a compartment for holding the food product;
a biodegradable multi-layer that is provided on the inner surface of the container and comprising:
   an inner cover layer comprising an amount of a biodegradable aliphatic polyester;
   a first intermediate layer of a biodegradable material for connecting and/or sealing adjacent layers;
   a functional layer comprising a polyvinylalcohol;
   a second intermediate layer of a biodegradable material for connecting and/or sealing adjacent layers; and
   an outer cover layer comprising an amount of a biodegradable aliphatic polyester,
      wherein the container comprises a moulded fiber matrix with an amount of biodegradable aliphatic polyester.

The food packaging unit according to the invention comprises a compartment capable of holding a food product. This involves receiving, containing and/or carrying such food product. For example, such compartment for holding a food product may relate to a compartment capable of holding a food product, such as eggs, tomatoes, kiwis, or a beverage, yoghurt, coffee milk, compounds for dispensing beverages such as tea, coffee, soups etc.

In the context of this invention degradable relates to degradation resulting in loss of properties, while biodegradable relates to degradation resulting from the action of microorganisms such as bacteria, fungi and algae. Compostable relates to degradation by biological process to yield carbon dioxide (CO₂), water, inorganic compounds and biomass.

According to the present invention the biodegradable multi-layer, preferably a laminated multi-layer, comprises at least five material layers. It will be understood that additional layers can also be provided in accordance to the present invention.

The inner and outer cover layer comprise an amount of a biodegradable aliphatic polyester, such as poly(butylene succinate) also referred to as PBS, polybutylene sebacate terephthalate also referred to as PBST, polyhdroxyalkanoate also referred to as PHA, for example including polyhdroxybutyraat also referred to as PHB and/or poly(3-hydroxybutyrate-co-3-hdroxyhexanoate) also referred to as PHBH and/or poly(3-hydroxybutyrate-co-3-hydrovalerate) also referred to as PHBV, polycaprolactone also referred to as PCL, poly(lactic acid) also referred to as PLA, poly(glycolic acid) also referred to as PGA, polybutyleneadipate-terphthalate also referred to as PBAT and also known with its commercial name ecoflex, and/or other suitable components, such as poly(alkylene dicarboxylate) other than PBS, PBAT and PBST, poly(lactic-co-glycolic acid) also referred to as PLGA, including mixtures or blends. An example of such a blend is a blend of PBAT and PLA, also known with its commercial name Ecovio, or a blend of PBAT and PBS, or another suitable blend that is preferably home compostable. In some of the presently preferred embodiments of the invention the biodegradable aliphatic polyester is bio-based. This further improves the sustainability of the packaging unit of the invention.

The inner and outer cover layer may also comprise a biodegradable composition of materials, such as a combination of starch and one of the aforementioned biodegradable aliphatic polyesters, such as PBS and/or PLA and/or PBAT and/or PBST. This improves the surface properties of the biodegradable (laminated) multi-layer, and also of any packaging unit provided therewith. This includes the so-called wipeability of the packaging unit. Wipeability relates to the possibility to remove stains from the surface and reducing or even preventing penetration into the material. Also, it may provide more possibilities for masking (hiding) undesirable stains and/or promoting the compostable effect of the packaging unit. The surface properties also relate to grease resistance such that the (chemical properties) of the packaging unit can be remained during its use, for example. Also, the penetration of oil originating from the food product, such as pasta or French fries or stew with or without gravy, into the packaging unit can be reduced. Also, water barrier properties can be improved to reduce the penetration of water and/or fatty liquids such as gravy or sauces into the packaging unit and thereby reducing ridging problems, for example.

In addition, the (laminated) multi-layer comprises a functional (central) layer that comprises a biodegradable and compostable polyvinyl alcohol, also referred to as a vinyl alcohol polymer, including co-polymers. This function layer contributes to the multi-layer properties, such as acting as a gas barrier. For example, the functional layer may provide an effective oxygen (O₂) barrier. This improves shelf-life of the food product(s) in the packaging unit.

In a presently preferred embodiment the vinyl alcohol polymer comprises a highly amorphous vinyl alcohol polymer (HAVOH), including copolymers such as butandiol vinyl alcohol co-polymer (BVOH). Such polymer or polymer mixture also provides an effective barrier, especially a gas barrier, and more specifically an oxygen (O₂) barrier. Such barrier can effectively be used to further improve the shelf-life of the food product(s). In addition, this also reduces food waste, thereby further improving the sustainable effects of the (food) packaging unit according to the present invention. Experiments showed a surprisingly effective oxygen (O₂) barrier, especially at relative humidities up to 60% as compared to conventional materials. An example of BVOH is G-Polymer.

As a further advantage, vinyl alcohol polymers are mouldable and extrudable. This renders it possible to co-extrude the laminated multi-layer as a co-extruded laminated multi-layer, optionally together with the basic material of a packaging unit, especially the basic material of the compartment(s) thereof, such as the moulded fiber, or alternatively moulded fluff (fiber), pulp material. The co-extruded material can be moulded or deep-drawn. This enables efficient and effective manufacturing processes for the packaging unit of the present invention. The efficiency can even be improved further by recycling the remainders after punching the material into the manufacturing process.

The inner and outer cover layers are separated from the central functional layer by an intermediate layer, to which can also be referred to as a tie layer. Such intermediate layer is substantially of a biodegradable material and connects and/or seals its adjacent layers. Preferably, the intermediate layers improve or at least contribute to maintaining the desired properties of the central functional layer, such as acting as a gas barrier. For example, the intermediate layers seal the central functional layer against liquid penetration to maintain the gas barrier properties of the functional layer. The (compostable) multi-layer can be manufactured using different techniques, for example using blown film and melt cast extrusion techniques, co-injection optionally with integrated outer and intermediate layers, and (paper) coating.

According to the invention the container comprises a moulded fiber matrix with an amount of biodegradable aliphatic polyester. The moulded fiber matrix comprises moulded pulp, optionally including so-called fluff pulp. The moulded fiber matrix may comprise a combination of soft wood and hard wood, optionally comprising agents like AKDs and/or wet strength agents that improve the release from the moulding machine. Such matrix may also comprise an amount of so-called virgin fibers.

By including an amount of biodegradable aliphatic polyester denesting properties of the packaging units, for example denesting the unit from a stack of packaging units and/or from an external holder, are improved. This is probably caused by the reduction in the degradation of strength, stability and/or rigidity of the container material in response to conditions involving a high humidity, pressure and/or temperature. This reduction is achieved by the inclusion of an amount of biodegradable aliphatic polyester in the matrix.

It will be understood that additional separate layers can be provided in the laminated multi-layer, for example, providing 7, 9 or 11 layers of material improving the overall properties of the laminated multi-layer, for example including grease barrier and odour barrier.

The packaging unit according to the invention is preferably compostable thereby providing a sustainable packaging unit. This provides a biodegradable alternative material to conventionally used plastics, for example. Also, this improves recycling properties of the biodegradable packaging units according to the invention. For example, in a recycling process the majority of the film may be removed in the so-called pulping process. In several of the presently preferred embodiments of the invention the packaging unit is also marine degradable, thereby further improving the sustainability of the packaging unit.

The packaging unit according to the invention shows a significant reduction in the water vapor transmission rate (WVTR) as compared to conventional packaging unit. For example, conventional packaging units show a WVTR of up to 200 g/m² d. Experiments with a multi-layer according to the present invention shows a WVTR below 5 g/m² d, and below 4 g/m² d, and 3 g/m² d. It will be understood that this is a significant improvement in WVTR. This also reduces loss of aroma significantly. This improves food quality and shelf-life. For example, due to the low(er) WVTR the packing of dry food products, like coffee, snacks, noodles, nuts and candy, is improved, such that shelf-life is extended. In addition, this enables the omission of additional packaging layers of the food and/or packaging unit. This enables a full biodegradable packaging unit with minimal material cost. This also reduces the need for a secondary packaging to maintain product quality. Also the oxygen barrier is improved with the packaging unit of the invention. Experiments showed that the oxygen transfer rate (OTR, at 23° C. and 0% RH) can even be reduced to below 2 ml/m² d. In a presently preferred embodiment of the invention the OTR is below 1 ml/m² d and more preferably even below 0.1 ml/m² d. This improves freshness of the food products and the shelf-life. Other barriers may relate to lactic acid barriers that is relevant for yoghurt, for example, and grease barriers that is relevant to margarine, for example. Experiments showed the applicability of the packaging unit according to the invention also in relation to these barriers and food products.

In a preferred embodiment of the invention the amount of biodegradable aliphatic polyester in the moulded fiber matrix is in the range of 0.1 to 12 wt % of the packaging unit preferably in the range of 0.5 to 8 wt %, more preferably in the range of 1 to 5 wt %, and most preferably in the range of 2 to 4 wt %.

By applying an amount of biodegradable aliphatic polyester in one of the aforementioned ranges, the sustainability and packaging characteristics of the (food) packaging units according to the present invention is significantly improved. The biodegradable aliphatic polyester is provided in the biodegradable (laminated) multi-layer and/or in the matrix of the moulded or fluff pulp material and/or as a separate layer. Applying an amount of biodegradable aliphatic polyester in these ranges provides packaging units that are both stable and strong, and further improve the denesting properties of the packaging unit. Another advantage when using a biodegradable aliphatic polyester in a (food) packaging unit is the constancy of size or dimensional stability.

In a preferred embodiment of the invention the biodegradable aliphatic polyester in the moulded fiber matrix comprises fibers.

Providing fibers of the biodegradable aliphatic polyester achieves a network of moulded and biodegradable aliphatic polyester fibers in the moulded fiber matrix. This further improves the strength of the packaging unit. In addition, it may improve barrier properties.

In a presently preferred embodiment of the invention the fibers comprise PBS and/or PBST and/or PBAT. Experiments have shown that the PBS fibers effectively melt into the matrix and form a strong network. This is also possible with PBST and/or PBAT fibers.

In a preferred embodiment of the invention the amount of non-fiber based material is below 25 wt %, preferably below 20 wt %, more preferably below 15 wt %, and most preferably below 10 wt %.

Experiments showed that limiting the amount of non-fiber based material to the aforementioned upper limits improves the overall sustainability of the packaging unit. In an example, the moulded fiber matrix contains about 5 wt % of non-fiber based material and the multi-layer also contains about 5 wt % of non-fiber based material. In the context of the present invention non-fiber based material includes biodegradable aliphatic polyester and polyvinyl alcohol.

In a preferred embodiment of the invention one or more of the intermediate layers of biodegradable material comprise a biodegradable aliphatic polyester. Preferably, the one or more intermediate layers of the multi-layer is fully biodegradable by providing it fully from a biodegradable aliphatic polyester.

In a further preferred embodiment of the invention the biodegradable packaging unit further comprises a cover or lid for sealing the compartment, wherein the cover or lid comprises the biodegradable multi-layer as described earlier in relation to the inner surface of the container.

Providing a cover or lid enables sealing or closing the compartment. This provides a sealed container with a compartment this is suitable for holding a product, such as a beverage and/or compounds for dispensing beverages such as tea, coffee, soups etc.

In a presently preferred embodiment of the invention the cover or lid further comprises a paper layer.

Providing a paper layer provides additional strength and stability to the packaging unit, in particular the cover or lid thereof. Furthermore, the paper layer enables display of information about the food product and/or manufacturer, for example. Preferably, the cover or lid further comprises a second paper layer. Such optional second paper layer is preferably provided on the other side of the laminated multi-layer to further enhance the properties of the packaging unit.

The paper layer is preferably from a so-called greaseproof paper, more preferably a greaseproof paper that classifies as a baking paper. This paper layer preferably comprises short length fibers, being free of halogenated compounds, such as so-called fluorochemicals, and is highly resistant to the permeability of oils and greases. The grease resistance is measured by the KIT value, through the KIT test, and for this kind of paper (layer) it is preferably of the value 12, which means the maximum possible grease/oil resistance that can be achieved. The paper layer may have different colours. Preferably, the paper layer is bond to the biofilm layers, through heat and pressure, for example at a temperature of 120° C. In addition, or as an alternative, the paper layer comprises an amount of micro-fibrillated cellulose fibers with an intense inter-fiber hydrogen (H₂) bonding.

In some of the presently preferred embodiments the paper layer is provided with an opening or cut or transparent part that acts as window for the packaging unit. Such window enables a consumer to see and inspect the contents of the packaging unit. A further advantage of such combination of a paper layer for display of information and a window for providing a view on the contents of the packaging unit is that it obviates the need for a separate (carton) sleeve around a ready-to-eat meal, for example. This significantly contributes to the reduction of waste.

In a further preferred embodiment of the invention, the biodegradable multi-layer comprises at least two functional layers.

Providing two or more functional layers improves the performance of the barrier layers and/or increases the flexibility to provide multiple barriers for optionally different properties. For example, a multiple barrier for oxygen can be applied or different barriers can be applied for oxygen and moisture. This improves the performance and/or flexibility.

Preferably, the at least two biodegradable multi-layers are separated by a layer of a biodegradable aliphatic polyester. Optionally, additional intermediate layers are provided.

In a presently preferred embodiment of the invention the thickness of the biodegradable multi-layer is in the range of 20 to 50 μm. In preferred embodiments the thickness of the biodegradable multi-layer is below 125 μm, preferably below 100 μm, more preferably below 90 μm, and is most preferably about 80 μm.

The thickness of the biodegradable multi-layer(s) provides a biodegradable laminated multi-layer having an acceptable thickness and providing effective barrier properties, for example. Optionally, one or more additional paper layers are provided in combination with the laminated multi-layer.

In one of the presently preferred embodiments of the invention the functional layer has a thickness in the range of 1.5 to 10 μm and is most preferably in the range of 3 to 7 μm. preferably, after deep-drawing, the layer thickness of the functional layer is in the range of 4 to 6 μm. The intermediate layers have a thickness that is preferably also in the range of 1.5 to 10 μm, more preferably in the range 1.5 to 5 μm, and most preferably in the range of 1.8 to 3 μm for an individual layer. Optionally, the multi-layer has a functional layer that is positioned asymmetrically. This positioning is achieved by having a different thickness of one or more of the corresponding layers on both sides of the functional layer, preferably the outer or cover layer on the food side of the multi-layer has a reduced thickness. This asymmetric positioning of the functional barrier layer enables thickness reduction (and cost reduction) of the layer in contact with the food and enables use of the thick(er) layer in contact with the tray to provide a good bonding. The principle of bonding the film to the fiber surface, preferably without the use of glue or adhesive layers, is based on bringing the multilayer structure close to the melting point of the layer that needs to bond/attach to the fiber tray. Therefore, a thicker layer at the fiber tray side enables a better mechanical bonding due to the fiber layer of the tray. The layers in contact with the food can be as thin as possible and just thick enough to protect the functional (barrier) layer, for example if this layer is water soluble and moisture sensitive. This further improves the packaging unit.

In such presently preferred embodiment the inner and outer cover layer have a thickness that is preferably in the range of 20 to 50 μm, more preferably in the range of 10 to 40 μm. As mentioned the inner (food side) and outer cover layer may have a different thickness. It will be understood that different combinations of layers and thicknesses can be made.

In such presently preferred embodiment it is presently preferred to have a total thickness of the biodegradable multi-layer with one functional layer in the range of 23 to 70 μm, more preferably in the range of 30 to 60 μm, even more preferably in the range of 30 to 50 μm, and most preferably a thickness of about 40 μm.

It will be understood that different combinations of layers and thicknesses can be made. In another presently preferred embodiment there is provided a biodegradable multi-layer having a total thickness of the biodegradable multi-layer in the range of 70 to 150 μm, preferably in the range of 75 to 120 μm, more preferably in the range of 70 to 90 μm, and most preferably a thickness of about 80 μm.

In a further alternative embodiment of the invention with two functional layers the total thickness is in the range of 100 to 150 μm, and is preferably about 125 μm. The outer cover layers preferably comprise a blend of PBAT and PLA or PBS, and have a thickness in the range of 30 to 35 μm. Two functional layers preferably comprise a polyvinyl alcohol, and have a thickness in the range of 3.5 to 4 μm and an additional flexibility layer has a thickness in the range of 30 to 40 μm. All these layers are preferably separated with an intermediate layer, preferably form a biodegradable material, such as PBS, having a thickness in the range of 3 to 5 μm. This embodiment therefore has 9 layers. In this embodiment the flexible layer is a blend of biopolymers, for example with PBS, PBAT and/or PBST. It will be understood that another number of layers can also be envisaged in accordance to the invention.

Experiments have shown an effective barrier, especially an oxygen barrier, having a lower weight that can be applied cost effectively.

Optionally, one or more additional paper layers are provided in combination with the laminated multi-layer to provide a cover or lid. In the context of the invention the cover or lid also covers a foil, more specifically a top seal film, wherein this top seal film is preferably provided with a similar multi-layer construction and a thickness in the range of 25 to 100 μm, more preferably in the range of 30 to 50 μm. The thickness of the intermediate and functional layers is preferably similar to the multi-layer mentioned earlier, while the inner and outer cover layers are provided with a reduced thickness. Optionally, one or more additional paper layers are provided in combination with the laminated multi-layer. In a number of applications the reduced thickness of the top seal film as compared to the laminated multi-layer is possible because the top seal film does not need to be deep-drawn in the manufacturing process.

This combination of container and cover or lid having barrier properties provides a packaging unit that is capable of holding a sealed food product.

Optionally, the (laminated) multi-layer comprises a colouring agent that is biodegradable and more preferably compostable.

By providing a colouring agent the visual appearance of the packaging unit provided can be improved. Furthermore, this can be used to provide a consumer with additional information. For example, Indian meals can be provided in a red coloured packaging unit, fish in a blue coloured packaging unit, and Italian food can be provided in a green coloured packaging unit. It will be understood that these examples can be extended to other exchanges of information with a consumer.

Optionally, in addition or as an alternative, a colouring agent is added to the moulded or fluff pulp of the packaging unit according to the invention, preferably as a soluble dye. These agents can be cationic or anionic and are in another classification also referred to as basic dyes, direct dyes or acid dyes. In a presently preferred embodiment cationic colouring agents are used. Optionally, the moulded or fluff pulp material can be coloured using additives, dyes (basic dyes, direct dyes, anionic and/or cationic charged dyes), pigments or other components that provide colour to the packaging unit. This enables providing the packaging unit with a colour representative for its (intended) contents.

In a further preferred embodiment of the invention the laminated multi-layer comprises a print. By providing a laminated multi-layer with a print the possibilities to provide a consumer with additional information or extended print.

In a further embodiment of the present invention the packaging unit further comprises an amount of natural and/or alternative fibers.

Providing an amount of natural and/or alternative fibers provides a natural feel to the packaging unit and/or improves the overall strength and stability of the packaging unit. Such natural/alternative fibers may comprise fibers from different origin, specifically biomass fibers from plant origin. This biomass of plant origin may involve plants from the order of Poales including grass, sugar cane, bamboo and cereals including barley and rice. Other examples of biomass of plant origin are plants of the order Solanales including tomato plants of which the leaves and/or stems could be used, for example plants from the Order Arecales including palm oil plants of which leaves could be used, for example plants from the Order Maphighiales including flax, plants from the Order of Rosales including hemp and ramie, plants from the Order of Malvales including cotton, kenaf and jute. Alternatively, or in addition, biomass of plant origin involves so-called herbaceous plants including, besides grass type plants and some of the aforementioned plants, also jute, Musa including banana, Amarantha, hemp, cannabis etc. In addition or as an alternative, biomass material origination from peat and/or moss can be applied.

Preferably, the (lignocellulosic) biomass of plant origin comprises biomass originating from plants of the Family of Poaceae (to which is also referred to as Gramineae). This family includes grass type of plants including grass and barley, maize, rice, wheat, oats, rye, reed grass, bamboo, sugar cane (of which residue from the sugar processing can be used that is also referred to as bagasse), maize (corn), sorghum, rape seed, other cereals, etc. Especially the use of so-called nature grass provides good results when manufacturing packaging units such as egg packages. Such nature grass may originate from a natural landscape, for example. This family of plants has shown good manufacturing possibilities in combination with providing a sustainable product to the consumer.

In another preferred embodiment the biomass of plant origin comprises material from the coffee plant (Coffea) in the family Rubiaceae. Optionally, this biomass is used in combination with other biomass. The coffee plant biomass can advantageously be used for coffee related products, such as coffee capsules.

Preferably, in one of the embodiments of the invention the packaging unit comprises an amount of micro fibrillated cellulose (MFC) sometimes also referred to as nanofibrillar cellulose or cellulose nanofibers or nanocellulose. MFC preferably originates from cellulose raw material of plant origin. The use of MFC enhances the fiber-fiber bond strength and further improves the reinforcement effect. Although MFC is preferably applied in combination with one or more of the biodegradable aliphatic polyesters, it is also possible to use MFC as an alternative to these components.

In an embodiment of the invention the bio-polymers and/or MFC provide a biofilm on or at (a part of) the surface of the packaging unit. Experiments indicate that good barrier properties can be achieved. Alternatively, or in addition thereto, a paper look and/or paper feel surface layer can be provided. For example, a paper layer can be sealed onto a thin layer of (bio)film or a thin layer of biofilm or biopolymer can be coated or laminated onto the paper layer. The biopolymer layer can be sealed onto the surface of a tray or container for food, for example. This paper look and/or paper feel surface layer contributes to the consumer's appreciation of the packaging unit according to such embodiment of the invention. Tests have shown a good wet strength and barrier properties. Barrier properties may include oxygen and/or grease and/or moisture barriers. It is believed that the oxygen barrier properties are achieved by the ability of MFC to form a dense network involving hydrogen bonds, for example.

Optionally, some hydrophobic elements are added to an MFC layer to further improve the water barrier properties. This may involve modification of the hydroxyl groups, for example on the surface of the micro fibrils chemically and/or by absorption of polymers, for example.

A further advantage of the use of MFC is the improved printability, including digital printing possibilities. In addition or as an alternative, MFC may reduce cost by reducing the weight or grammage by increasing the amount of fillers. This may also enhance the optical properties.

It will be understood that combinations of MFC and/or biodegradable aliphatic polyesters may further improve the mentioned effects and advantages. Also, combinations with conventional polymer films, for example by coating MFC and/or a biodegradable aliphatic polyester thereon, may provide a product with the advantages of both types of material. As a further example, a combination of biodegradable aliphatic polyester, such as PBS, PBAT, PBST with cellulose fibers significantly reduces the swelling of the packaging material. These cellulose fibers may be a mixture of short fiber hard wood pulp (e.g. birch) and long fiber soft wood pulp. In a presently preferred embodiment the long fibers have an average length of about 2 to 3 mm, and preferably about 2.5 mm, the short fibers have an average length of about 0.5 to 1.2 mm, and preferably about 0.9 mm.

In a presently preferred embodiment the matrix of the packaging unit comprises an amount of calcium carbonate.

Providing an amount of calcium carbonate provides a smoother surface. This improves denesting properties and printability of the surface. In addition, it further reduces fiber swelling and penetration of compounds, such as coffee, into the matrix and/or fibers. Furthermore, dewatering is improved. This enables higher machine speeds in manufacturing the packaging units and/or reduces the energy costs as less water needs to be evaporated in the drying process. In addition, providing an amount of calcium carbonate enhances the strength stiffness properties improves even the oxygen transfer rate (OTR) barrier properties and can smoothen the surface to improve printability, in mould labelling, decoration in general Calcium carbonate can be provided as a so-called filler material to the matrix and/or can be used in combination with other materials.

Preferably, the matrix comprises a mixture of MFC and calcium carbonate, more preferably with an amount of 5 to 10 wt % of the matrix. In this or other embodiments of the invention the amount of calcium carbonate is in the range of 1 to 12 wt %, preferably in the range of 2.5 to 11 wt %, and most preferably in the range of 5 to 10 wt %. This even further improves product properties, such as strengthening of the product, smoothening of the surface of the product, enhancing denestability, improving printability, and being less sensitive for swelling.

The present invention further also relates to a method for manufacturing a biodegradable packaging for a food product, the method comprising the step of:
providing a container with an outer surface and an inner surface at least partly defining a compartment for holding the food product;
providing a biodegradable multi-layer that is provided on the inner surface of the container and comprising:
   an inner cover layer comprising an amount of a biodegradable aliphatic polyester;
   a first intermediate layer of a biodegradable material for connecting and/or sealing adjacent layers;
   a functional layer comprising a vinyl alcohol polymer;
   a second intermediate layer of a biodegradable material for connecting and/or sealing adjacent layers; and
   an outer cover layer comprising an amount of a biodegradable aliphatic polyester,
      wherein the container comprises a moulded fiber matrix with an amount of biodegradable aliphatic polyester.

Such method provides the same or similar effects and advantages as described in relation to the packaging unit. Optionally, the (laminated) multi-layer can be provided before or after releasing the food packaging unit from the mould. In one of the presently preferred embodiments the (laminated) multi-layer of the packaging element is co-extruded with the moulded pulp material and thereafter deep-drawn into the desired shape of the packaging unit. In another presently preferred embodiment the layer is provided in an in-mould operation, preferably in combination with an in-mould drying operation.

In a further preferred embodiment the method comprises the additional step of subjecting the packaging unit to a heating step heating the packaging unit to a temperature about the melting temperature of the biodegradable aliphatic polyester to crosslink/interact the packaging unit with the laminated multi-layer to melt or fuse it with at least a part of the inner surface of the packaging unit. This improves strength and/or barrier properties of the packaging unit. Preferably, the heating step heats the temperature of the packaging unit to a heating temperature in the range of 145 to 195° C., preferably in the range of 165 to 190° C., and most preferably to a temperature of about 180° C.

Preferably, a layer of biodegradable aliphatic polyester is provided on a contact surface of the matrix to improve melting or fusing of the laminated multi-layer thereon.

In a further preferred embodiment of the invention, the method comprises the step of providing a cover or lid, wherein the cover or lid comprises the biodegradable multi-layer. In another presently preferred embodiment the multi-layer is provided with one or more paper layers to act as a cover of lid for the compartment.

In one of the presently preferred embodiments, the method further comprises the step of performing (dry) sterilisation and pasteurisation on the (filled) packaging units. Especially, in combination with the oxygen (O₂)-barrier properties of the laminated multi-layer (and top seal film) the shelf-life of the food product is significantly improved. In addition, the O₂-barrier prevents or at least reduces oxidation processes in the food and thereby contributes to the maintenance of food taste.

In the life cycle of the packaging unit, in the context of the present invention, the manufacturing process of the packaging element and/or food packaging unit preferably also comprises the step of biodegrading the packaging element and/or packaging unit. Therefore, in relation to the present invention, preferably also the biodegradation of the packaging element and/or packaging unit is considered part of the entire manufacturing process. The biodegradation constitutes a significant part of the life cycle in view of the sustainability.

Preferably, the biodegrading comprises decomposing the food packaging unit.

Even more preferably, the decomposing is performed at a temperature in the range of 5 to 40° C., preferably in the range of 10 to 30° C., more preferably in the range of 15 to 25° C., and most preferably at a temperature of about 20° C., thereby relating to ambient decomposing.

In presently preferred embodiments the bio-polymers that are applied originate from so-called non-gmo (non-genetically modified organisms) biopolymers.

In some of the preferred embodiments the method further comprises the steps of refining fibers for the moulded or fluff pulp material and/or adding an amount of natural fibers. This provides the same or similar effects and advantages as were described in relation to the packaging unit.

The invention further also relates to a coffee capsule, with the coffee capsule comprising:
a container with an outer surface and an inner surface at least partly defining a compartment for holding the food product;
a biodegradable multi-layer that is provided on the inner surface of the container and comprising:
   an inner cover layer comprising an amount of a biodegradable aliphatic polyester;
   a first intermediate layer of a biodegradable material for connecting and/or sealing adjacent layers;
   a functional layer comprising a vinyl alcohol polymer;
   a second intermediate layer of a biodegradable material for connecting and/or sealing adjacent layers; and
   an outer cover layer comprising an amount of a biodegradable aliphatic polyester,
   a cover or lid comprising a biodegradable multi-layer.

Such coffee capsule provides the same or similar effects and advantages as described in relation to the packaging unit and/or manufacturing method. For example, the compartment of the capsule is configured for holding a food product, wherein such compartment may relate to a compartment capable of holding compounds for dispensing beverages such as tea, coffee, soups etc. It is noted that in the context of this invention the coffee capsule may also relate to these other compounds.

In preferred embodiments the coffee capsule according to the invention comprises one or more of the features that are described in relation to the packaging unit in general, including but not limited to the use of a specific amount of biodegradable aliphatic polyester in the moulded fiber matrix, the use of fibers, application of multiple functional layers, application of natural and/or alternative fibers, the use of a colouring agent to indicate coffee types, for example. Also carbon carbonate can be applied in the matrix as described in relation to the packaging unit in general.

The container of the capsule preferably comprises a moulded fiber matrix that may comprise a combination of soft wood and hard wood, optionally comprising agents like AKDs and/or wet strength agents that improve the release from the moulding machine. Such matrix may also comprise an amount of so-called virgin fibers.

Specifically, the coffee capsule according to the invention shows a significant reduction in the water vapor transmission rate (WVTR) as compared to conventional coffee capsules. For example, these conventional capsules show a WVTR of up to 200 g/m² d. Experiments with a multi-layer according to the present invention shows a WVTR below 5 g/m² d, and below 4 g/m² d, and 3 g/m² d. It will be understood that this is a significant improvement in WVTR. This also reduces loss of aroma significantly. This improves food quality and shelf-life. In addition, this enables the omission of additional packaging layers or holders as a secondary packaging of the coffee capsule. This enables a full biodegradable packaging unit with minimal material cost. Also the oxygen barrier is improved with the coffee capsule of the invention. Experiments showed that the oxygen transfer rate (OTR) can even be reduced to below 2 ml/m² d. This improves freshness of the compounds in the capsule and the shelf-life.

In preferred embodiments of the capsule according to the invention, the matrix comprises a mixture of MFC and calcium carbonate, more preferably with an amount of 5 to 10 wt % of the matrix. In this or other embodiments of the invention the amount of calcium carbonate is in the range of 1 to 12 wt %, preferably in the range of 2.5 to 11 wt %, and most preferably in the range of 5 to 10 wt %. This improves denesting properties and printability of the surface. In addition, it further reduces fiber swelling and penetration of coffee (products), into the matrix and/or fibers. Furthermore, dewatering improved. This enables higher machine speeds in manufacturing the packaging units and/or reduces the energy costs as less water needs to be evaporated in the drying process.

A further effect of the coffee capsules according to the invention is the carbon footprint reduction as compared to conventional aluminium unit. This provides a more sustainable capsule.

Preferably, the biodegradable multi-layer of the cover or lid comprises:
an inner cover layer comprising an amount of a biodegradable aliphatic polyester;
a first intermediate layer of a biodegradable material for connecting and/or sealing adjacent layers;
a functional layer comprising a vinyl alcohol polymer;
a second intermediate layer of a biodegradable material for connecting and/or sealing adjacent layers; and
an outer cover layer comprising an amount of a biodegradable aliphatic polyester. Also, preferably, the layer is combined with a carrying layer.

Applying a biodegradable multi-layer as a cover or lid provides a fully biodegradable coffee capsule with good WVTR and OTR, for example. In the context of this invention a cover or lid can also be referred to as a seal. Optionally, one or more paper layers can be applied in combination with the multi-layer in a similar manner as described earlier for the packaging unit in general. For example, a combination of biodegradable aliphatic polyester, such as PBS, PBAT, PBST with cellulose fibers significantly reduces the swelling of the packaging material. These cellulose fibers may be a mixture of short fiber hard wood pulp (e.g. birch) and long fiber soft wood pulp. In a presently preferred embodiment the long fibers have an average length of about 2 to 3 mm, and preferably about 2.5 mm, the short fibers have an average length of about 0.5 to 1.2 mm, and preferably about 0.9 mm.

In a presently preferred embodiment the capsule comprises a rim or ring, preferably of a biodegradable aliphatic polyester such as PBST, PBS, PBAT. Such rim increases strength and stability of the capsule under all conditions and/or improves denesting properties including removal from the machine.

Experiments showed good results with compounds for dispensing coffee. It will be understood that the features described in relation to the packaging unit of the invention can also be applied to the coffee capsule. For example, the container of the coffee capsule comprises a moulded fiber matrix with an amount of biodegradable aliphatic polyester. Optionally the carrying layer comprises a paper layer.

In some of the presently preferred embodiment of the coffee capsule according to the invention an amount of biomass is included. In one of the presently preferred embodiments the biomass originates from the coffee plant (Coffea in the family Rubiaceae).

Further advantages, features and details of the invention are elucidated on the basis of preferred embodiments thereof, wherein reference is made to the accompanying drawings, in which:

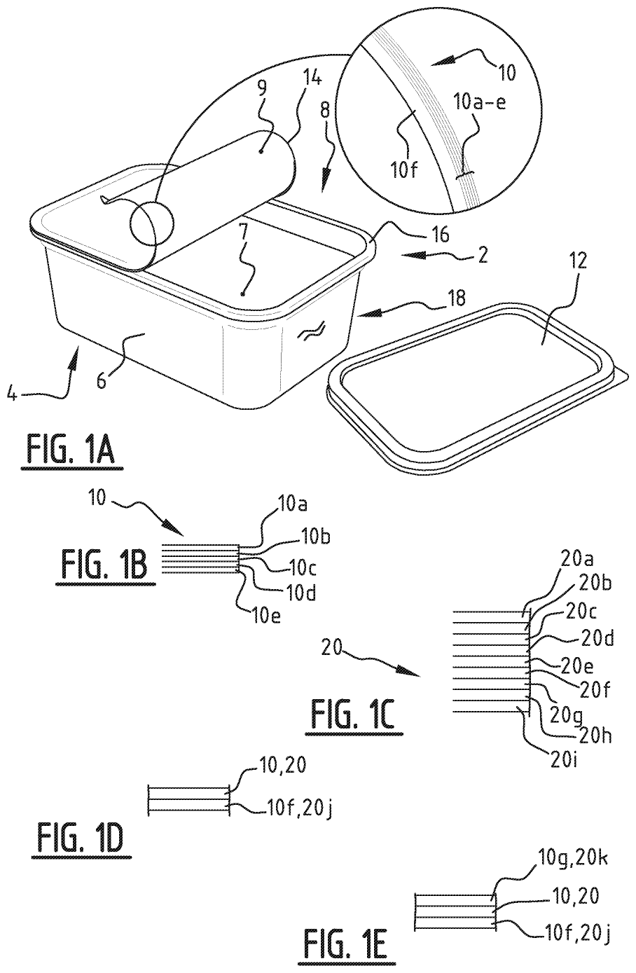

FIG. 1A shows a packaging unit for margarine having a packaging unit according to the present invention;

FIG. 1B-C show different embodiments of a multi-layer barrier layer for a packaging unit according to the invention;

FIG. 1D-E show different embodiments of a multi-layer barrier layer with one or more paper layers for a packaging unit according to the invention;

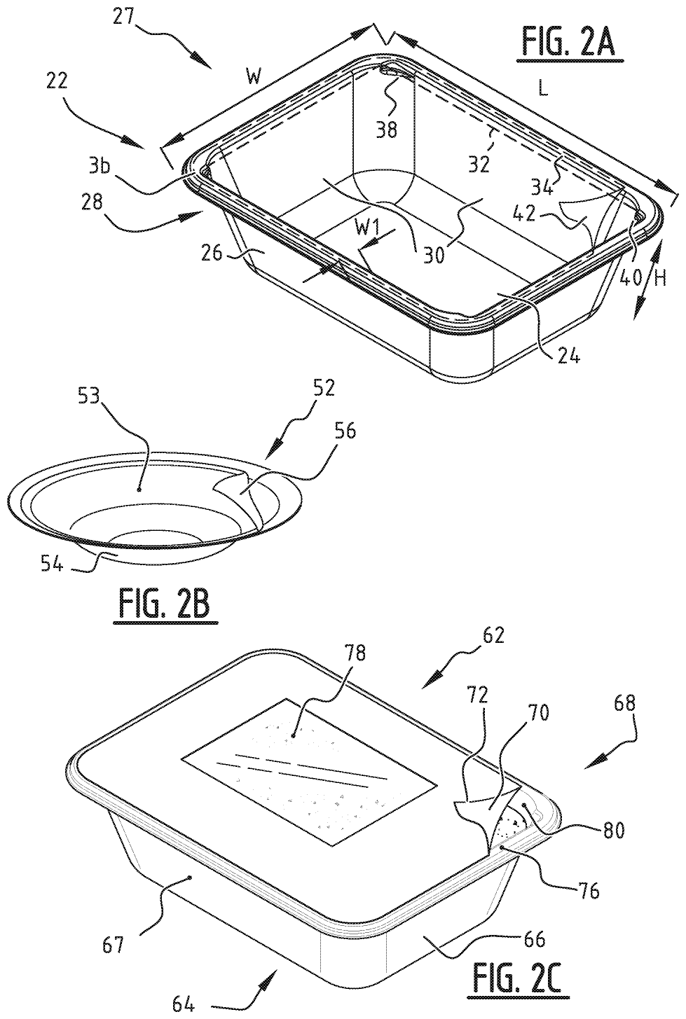

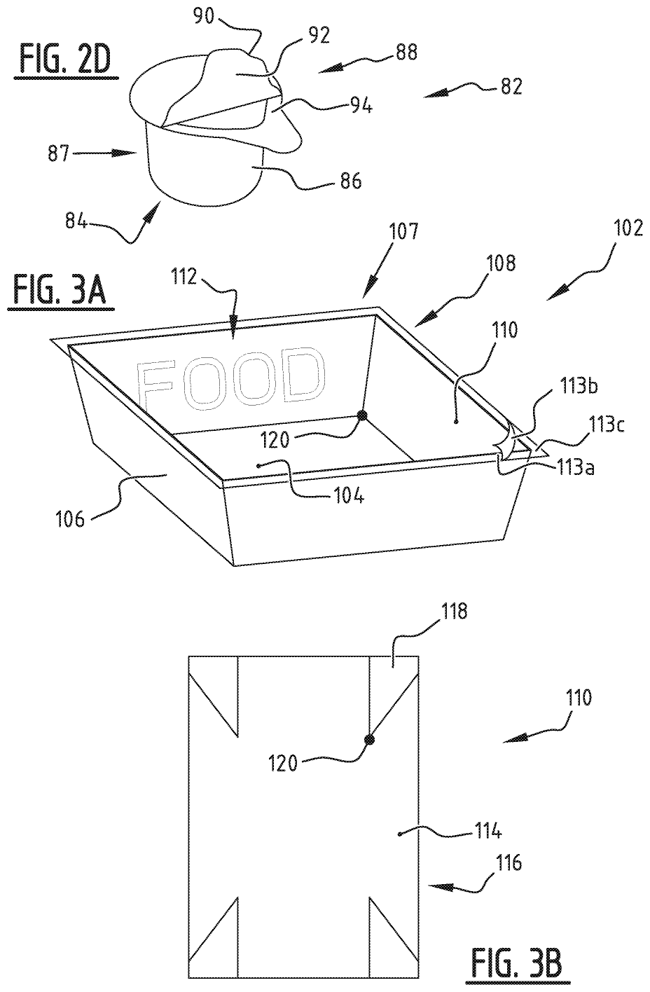

FIG. 2A shows an alternative packaging unit according to the present invention;

FIG. 2B shows a plate as food receiving product according to the invention;

FIG. 2C shows a food tray according to the invention having a paper layer with window;

FIG. 2D shows a container for coffee milk having a packaging lid element according to the invention as a foil;

FIGS. 3A and 3B show a packaging unit with laminated layer configured for receiving a food product according to the present invention;

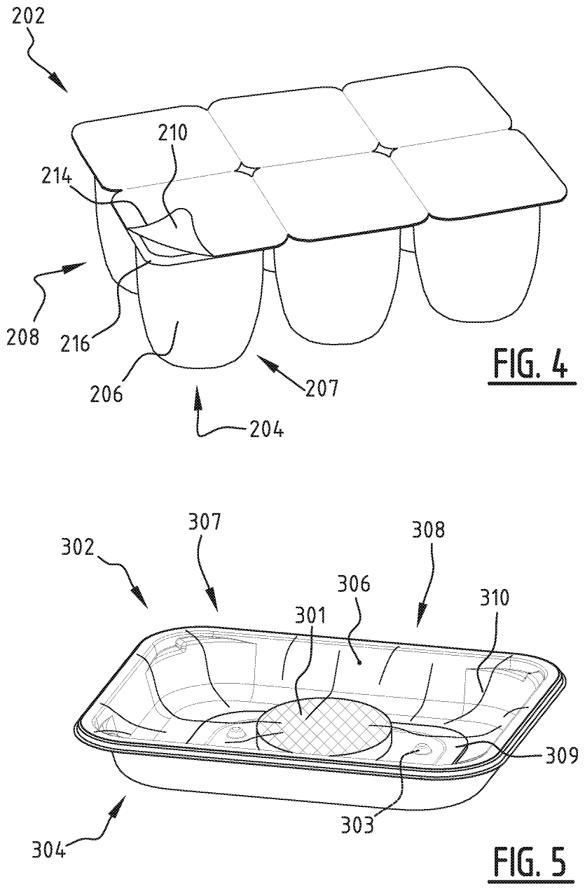

FIG. 4 shows a container for yoghurt according to the invention;

FIG. 5 shows a meat dish as a packaging unit according to the invention;

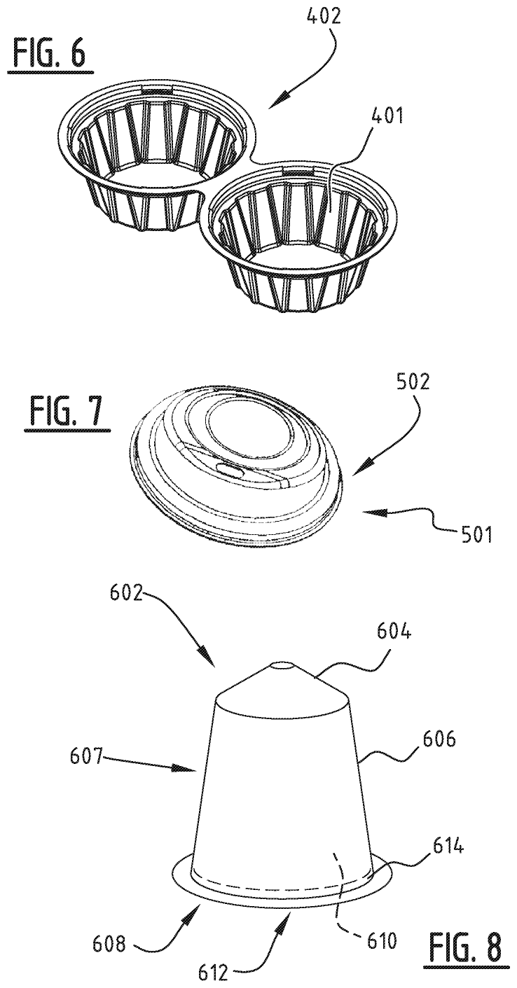

FIG. 6 shows an ice cup cover as alternative packaging unit according to the invention;

FIG. 7 shows a sip lid according to the invention;

FIG. 8 shows a coffee capsule according to the invention;

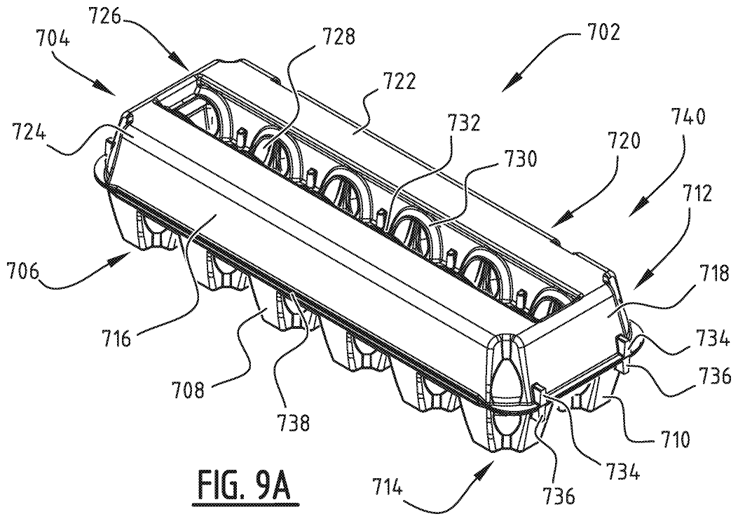

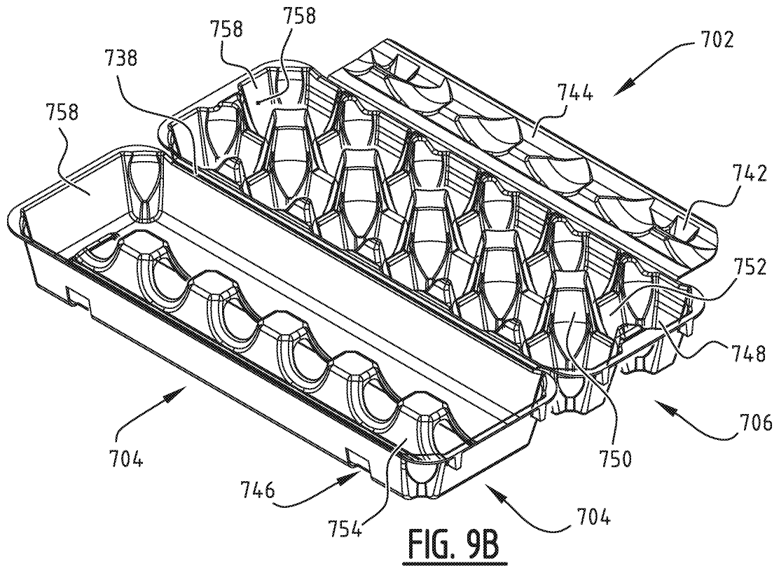

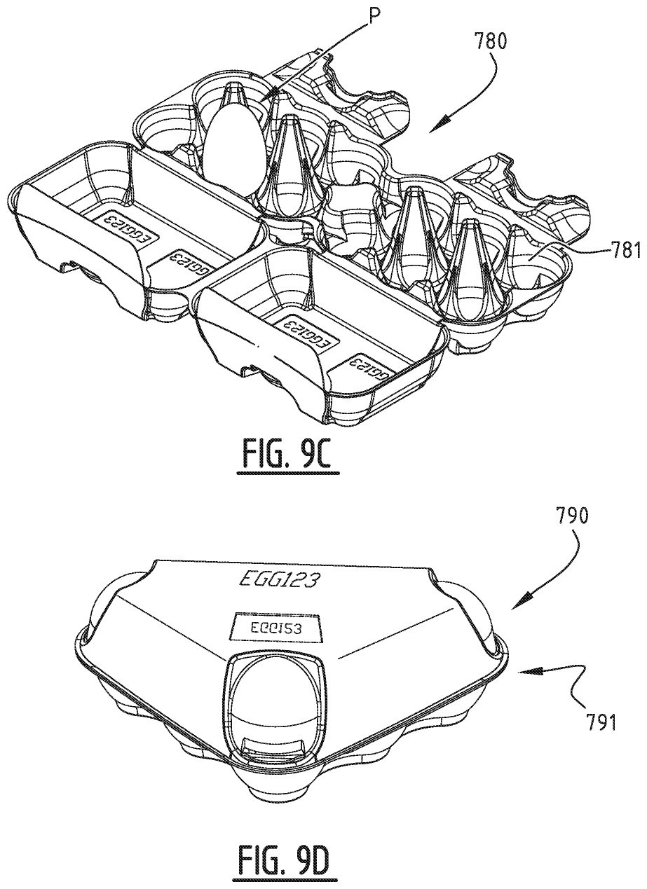

FIG. 9A-D show egg packages units according to the invention comprising a multi-layer; and

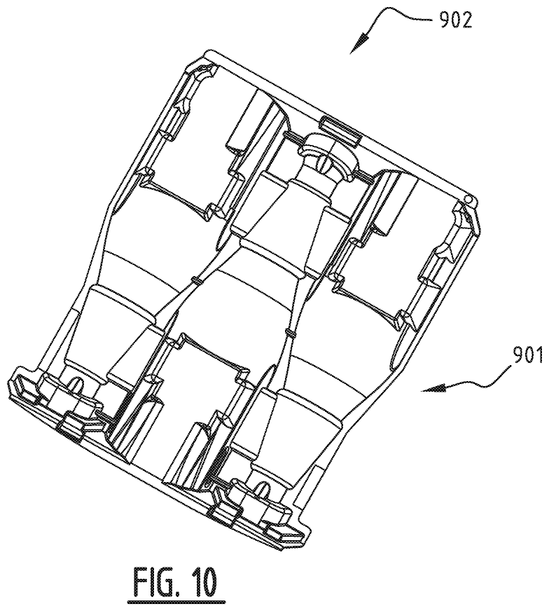

FIG. 10 shows a bottle divider according to the present invention.

Packaging unit 2 (FIG. 1A) relates to a container for margarine or other products. Container 2 has bottom part 4 and side walls 6 defining compartment 7 and opening 8. Before use, opening 8 is covered with cover or seal 9 comprising a biodegradable laminated multi-layer 10. In this embodiment there is provided a separate lid 12.

In the illustrated embodiment container 2 is provided with peelable cover or seal 9. Edge 14 of cover or seal 9 is peeled from edge 16 of container 2. In this embodiment multi-layer 10 comprises a number of layers as transparent film and a paper layer. It will be understood that layers can also be provided as non-transparent, or alternatively as semi-transparent and/or partly transparent. Alternatively, container 2 can also be provided only with cover or seal 9 and without cover 12. This may also be applied to other type of packaging units, for example to in instant or ready-to-eat meals, such that conventional sleeves can be omitted from the packaging units. This enables a more cost-efficient packaging unit with a possible weight reduction.

Container 2 is manufactured from a moulded pulp material and optionally comprises an additional film layer of biodegradable aliphatic polyester, such as PBS and/or PLA and/or PBST and/or PBAT, on the inner surface and comprises an amount of biodegradable aliphatic polyester that is blended into the moulded pulp. This renders bottom part 4 and/or walls 6 water or liquid repellent and/or improves the heating step to melt or fuse laminated multi-layer 10 on or to edge 16. One of the further advantages of the use of biodegradable aliphatic polyester is the reduction or prevention of the liquid entering or migrating into the material during use. Another advantage is the constancy of size or dimensional stability. Furthermore, denesting properties are improved. Container 2 can be used for different products. For example, container 2 is capable of holding an amount of margarine or ice cream.

Optionally, fibers 18 are included in the matrix of container 2. This improves the possibilities for giving the unit a natural paper feel and/or look. This may also be applied to other type of packaging units.

Biodegradable cover or seal 9 comprises a laminated multi-layer 10 (FIG. 1B) comprising first cover layer 10a, first intermediate layer 10b, central functional layer 10c, second intermediate layer 10d, and second cover layer 10e. It will be understood that other layers can be added to multi-layer 10. It will be understood that laminated multi-layer 10 can be applied to container 2 and/or other packaging units that are illustrated or are not illustrated.

An alternative biodegradable cover or seal 9 with a laminated multi-layer 20 (FIG. 1C) comprises first cover layer 20a, first intermediate layer 20b, first functional layer 20c, second intermediate layer 20d, central flexible layer 20e, third intermediate layer 20f, second functional layer 20g, fourth intermediate layer 20h, and second cover layer 20i. It will be understood that other layers can be added to multi-layer 20. It will be understood that laminated multi-layer 20 can be applied to container 2 and/or other packaging units that are illustrated or are not illustrated.

In an alternative embodiment (FIG. 1D) multi-layer 10, 20 comprises paper layer 10f, 20j. In a further alternative embodiment (FIG. 1E) multi-layer 10, 20 comprises additional second paper layer 10g, 20k. In this embodiment paper layers 10f, 20j, and 10g, 20k provide a sandwich type configuration for multilayers 10a-e, 20a-i.

Packaging unit 22 (FIG. 2A) provides a further embodiment of a food receiving container having bottom part 24 and side walls 26 defining compartment 27 and opening 28. Packaging unit 22 has length L, width W and height H. On the inside of container 22 there is provided laminated multi-layer 30, optionally comprising a print. In the illustrated embodiment laminated multi-layer 30 is provided on the inside of packaging unit 22 and extends from bottom part 24 up to contour or edge 32. Contour or edge 32 is provided a small distance from the upper side of edge 34. This distance is preferably in the range of 1 to 12 mm Edge 34 is provided with width W1 that defines contact surface 36 for connecting to liner or seal 33 that is schematically illustrated. In the illustrated embodiment this liner or seal 33 is connected directly to the moulded pulp material, optionally with an adhesive, in stead of being connected to laminated multi-layer 30. Such adhesive preferably comprises an amount of biodegradable polyester, for example PLA and/or PBS and/or PBST and/or PBAT. Width W1 is in the illustrated embodiment in the range of 1 to 15 mm, preferably in the range of 2 to 5 mm.

In the illustrated embodiment packaging unit 22 (FIG. 2A) comprises first denesting elements 38 and second denesting elements 40. In the illustrated embodiment denesting elements 38, 40 enable denesting of a stack of packaging units 22. It will be understood that alternative denesting elements can also be envisaged in accordance with the present invention as alternatives or in combination.

In the illustrated embodiment, optional cover or top seal film 42 is preferably provided from laminated multi-layer 10, 20 with paper layer 10f, 20j.

Packaging unit 22 (FIG. 2A) has numerous applications, including but not limited to, airplane meals. Such meals are provided to the airplane after (dry) sterilisation and pasteurisation. In combination with the oxygen (O₂)-barrier properties of the (laminated) multi-layer (and top seal film) the shelf-life of the food product is significantly improved. In addition, the oxygen (O₂)-barrier prevents or at least reduces oxidation processes in the food and thereby contributes to the maintenance of food taste.

In another embodiment of a packaging unit according to the invention, plate 52 (FIG. 2B) is on the food receiving side provided with (laminated) multi-layer 53, for example an aforementioned multi-layer 10, 20. In the illustrated embodiment bottom or back side 54 of plate 50 is not provided with such (laminated) multi-layer 53. Optionally, plate 50 is provided with cover or top seal film 56, for example in case of plate 50 holding a salad or soup. It will be understood that also other food products can be contained by plate 50.

Food tray 62 (FIG. 2C) comprises bottom part 64 and side walls 66 defining compartment 67 configured for receiving and holding a product, and opening 68. Before use, opening 68 is covered with cover 70 comprising a biodegradable (laminated) multi-layer 72.

In the illustrated embodiment container 62 is provided with peelable cover 70. Edge 74 of cover 70 is peeled from edge 76 of container 62. In this embodiment cover 70 comprises a number of layers 10a-e, 20a-i, including a transparent film and paper layer 10f, 20j. It will be understood that layers can also be provided as non-transparent, or alternatively as semi-transparent and/or partly transparent. In the illustrated embodiment paper layer 10f, 20k is provided with opening 78 enabling a consumer to inspect the contents of compartment 67.

Inner surface 80 of packaging unit 62 comprises PBS and/or PLA and/or PBAT and/or PBST material that is blended and/or integrated with the fibres of the moulded pulp material in the matrix. Optionally, the material is provided as additional film layer. In the illustrated embodiment container 62 is manufactured from a moulded pulp or fluff pulp material, optionally comprising an amount of natural fibers. This improves the possibilities for giving packaging unit 62 a natural paper feel and/or look. This may also be applied to other type of packaging units. For example, in instant or ready-to-eat meals, such that conventional sleeves can be omitted from the packaging units. This enables a more cost-efficient packaging unit with a possible weight reduction.

Container 82 (FIG. 2D) for holding coffee milk comprises bottom part 84 and side walls 86 defining compartment 87 with opening 88. Before use, opening 88 is covered with cover or seal 90 comprising a biodegradable laminated multi-layer, preferably according to one of the embodiments illustrated in FIGS. 1B-E. In the illustrated embodiment container 82 is provided with peelable cover 90. Edge 92 of cover 90 is peeled from edge 94 of container 82.

Packaging unit 102 (FIG. 3A) relates to a food receiving container having bottom part 104 and side walls 106 defining compartment 107 and opening 108. On the inside of container 102 there is provided (laminated) multi-layer 110 comprising a compostable/biodegradable vinyl alcohol polymer. In the illustrated embodiment layer 110 comprises print 112. Preferably, in the illustrated embodiment the print is provided on the back side of laminated multi-layer 110.

In the illustrated embodiment container 102 is provided with peelable cover/top seal film 113a (FIG. 3A). Edge 113b is shown as peeled from edge 113c of container 102. In this embodiment top seal film 113a is shown as transparent film. It will be understood that film 113a can also be provided as non-transparent, or alternatively as semi-transparent and/or partly transparent. Alternatively container 102 can also be provided without top seal film 113a.

In an illustrated embodiment, laminated multi-layer 110 (FIG. 3B) comprises a food oriented side 114 and a packaging side 116. In the illustrated embodiment parts 118 can be removed or cut from sheet or layer 110 to dimension laminated multi-layer 110 according to the specifications and enable providing layer 110 into the inside of container 102. This enables positioning laminated multi-layer 110 correctly relative to corners 120. In this illustrated embodiment print 112 is provided in a mirror image on package side 116 of laminated multi-layer 110 to render the render print 112 visible for a user or consumer.

Container 202 (FIG. 4) for holding a food product such as yoghurt comprises bottom part 204 and side walls 206 defining compartment 207 with opening 208. Before use, opening 208 is covered with packaging element 210 comprising a biodegradable laminated multi-layer 210.

In the illustrated embodiment container 202 is provided with peelable cover 210. Edge 214 of packaging element 210 is peeled from edge 216 of container 202. In this embodiment packaging element 210 comprises a number of layers similar to multi-layer 10, 20, optionally including a transparent film and paper layer. It will be understood that layers can also be provided as non-transparent, or alternatively as semi-transparent and/or partly transparent.

Packaging unit 302 (FIG. 5) for holding meat 301 comprises bottom part 304 and side walls 306 defining compartment 307 with opening 308. Bottom part 304 comprises a number of protrusions or spikes 303. In the illustrated embodiment meat 301 rests on foil 309 and is covered by cover/seal 310 having a number of layers that are preferably transparent. Lower foil 309 also comprises a number of layers and/or comprises an absorbent material.

A further example in accordance with the present invention is cover 402, for example for an ice cup (FIG. 6) that is provided with (laminated) multi-layer 401. Another example of a packaging unit according to the invention is sip lid 502 (FIG. 7) that is provided with (laminated) multi-layer 501. Multi-layers 401, 501 are preferably similar to multi-layer 10, 20 that was already illustrated. Cover 402 and sip lid 502 comprise an additional film layer of biodegradable aliphatic polyester and and/or may comprise an amount of biodegradable aliphatic polyester that is blended into the moulded pulp. This renders cover 402 and sip lid 502 water or liquid repellent and/or improves the heating step to melt or fuse laminated multi-layer 401, 501 on or to cover 402 and/or sip lid 502. One of the further advantages of the use of biodegradable aliphatic polyester is the reduction or prevention of the liquid entering or migrating into the sip lid material during use. Another advantage is the constancy of size or dimensional stability. In this specific case this prevents sip lid 502 loosening from a cup or beaker for hot beverages such as coffee, tea or soup, or cold beverages such as carbonated drinks, and cup 402 from loosing from an ice cup, for example. It will be understood that such lids 502 can also be applied to other food containers. For example, lids 502 can be applied to containers for milkshakes, for example. Further details and examples of lids 502 are disclosed in WO 2010/064899, including embodiments with specific flanges and notches.

Sip lid 502 is preferably coated with a biodegradable aliphatic polyester liner, such as a PBS and/or PBAT and/or PBST liner in addition to (laminated) multi-layer 501 to improve the melting properties. As mentioned, sip lids 502 can be used for cups and milkshakes. Also, sip lids can be applied to so-called ready meal trays (for example, for pizza, wraps, fish, meat, lobster, pasta) and act as a (digital) printable and barrier seal, for example.

In an alternative embodiment packaging unit 602 relates to a coffee capsule (FIG. 8) and is provided with 604 and side walls 606 defining compartment 607 with opening 608. On the inside of container 602 there is provided (laminated) multi-layer 610 comprising a compostable/biodegradable vinyl alcohol polymer, preferably similar to multi-layer 10, 20. Compartment 607 holds a compound for dispensing beverages such as tea, coffee, soups etc. In the illustrated embodiment capsule 602 is provided with peelable cover/top seal film 612 that preferably comprising a multi-layer, preferably similar to multi-layer 10, 20 and not necessarily with the same configuration and/or composition as multi-layer 610. For example, cover 612 may comprise a multi-layer with more or less layers as compared to multi-layer 610 of compartment 607. Cover 612 is provided with sufficient strength to prevent undesired breaking in storage, transport and in the machine. Such sufficient strength guarantees sufficient seal integrity.

In use, capsule 602 is punctured to enable penetration of water with a temperature of 90 to 95° C. and a pressure that may be in the range of 10 to 15 bar. Brewing may take 20 to 25 seconds, for example. Multi-layer 610 prevents penetration of coffee into the matrix of compartment 607. Optionally, rim or ring 614 is provided to increase strength and/or denesting properties including removal from the machine. In the illustrated embodiment rim 614 is provided at or close to opening 608 of compartment 607.

Packaging unit 702 (FIGS. 9A and 9B) carries or holds eggs and comprises cover part 704 and bottom part 706. In the illustrated embodiment packaging unit 702 comprises laminated multi-layer 701. Multi-layer 701 is preferably similar to multi-layer 10, 20 that was already illustrated. Bottom part 706 is provided with back surface 708, sides 710 and front surface 712, and bottom surface 714. Cover part 704 is provided with back surface 716, side surfaces 718, front surface 720 and top surface 722. In the illustrated embodiment transition 724 is provided between top surface 722 and back and front surfaces 716, 720.

In the illustrated embodiment, top surface 722 of cover part 704 is provided with groove 726 comprising a number of openings 728. Openings 728 are defined by two adjacent arch-shaped edges 730, 732 having a larger thickness as compared to the average thickness of cover part 704.

Side surfaces 718 of cover part 704 are provided with denest nocks or denest elements 734. In the illustrated embodiment, bottom part 706 is provided with similar elements 736 mirroring denest elements 734. Hinge 738 connects back surface 716 of cover part 704 with back surface 708 of bottom part 706. Lock 740 comprises nose-shaped lock element 742 that is connected to flap 744 of bottom part 706. Cover part 704 is provided with openings 746 that capture lock elements 742 therewith defining lock 740.

In the illustrated embodiment, bottom part 706 is provided with a number of product receiving compartments 748, cones 750 and separating walls 752. Cone 750 extends from the bottom of bottom part 706 in an upward direction. Cover part 704 comprises cone support 754. Inner surface 758 of packaging unit 702 comprises PBS and/or PLA and/or PBAT and/or PBST material, optionally as film layer or alternatively blended and/or integrated with the fibres of the moulded pulp material. It will be understood that other configurations can also be envisaged in accordance to the invention. Packaging unit 702 may also be configured to receive other products, such as tomatoes, kiwis.

It will be understood that other designs for packaging units in accordance with the invention can be envisaged. For example, containers 780, 790 (FIGS. 9C and D) illustrate different designs for egg cartons capable of holding eggs P and comprise (laminated) multi-layer 781, 791. Multi-layers 781, 791 are preferably similar to multi-layer 10, 20 that was already illustrated.

As a further example, bottle divider 902 (FIG. 10) is illustrated with laminated multi-layer 901. Multi-layer 901 is preferably similar to multi-layer 10,20 that was already illustrated. Also, bottle divider 902 may comprise an additional film layer of PBS (and/or appropriate alternative biodegradable aliphatic polyester such as PBST and/or PBAT) and/or may comprise an amount of PBS and/or PBST and/or PBAT that is blended into the moulded pulp.

It will be understood that other types of food packaging units and/or packaging elements can also be envisaged in accordance with the present invention. Other examples of food packaging products may relate to cup carriers, cups, plates and other table ware etc.

In the manufacturing process of a packaging unit a moulded pulp material is prepared. An amount of biodegradable aliphatic polyester, such as PBS and/or PHBH, is blended or mixed into the moulded pulp material. Optionally, an amount of biodegradable aliphatic polyester, such as PBS and/or PHBH and/or PLA and/or PBST and/or PBAT is included in a separate layer that is provided in or on the packaging unit. Preferably, the laminated multi-layer is co-extruded with the moulded pulp material and deep-drawn. In addition, or as an alternative, the raw unit is moulded. Optionally, the raw unit is dried in the mould applying an in-mould drying process. In such alternative embodiment laminated multi-layer can be provided in the mould and a heating step is performed. Optionally, an additional layer of biodegradable aliphatic polyester is provided to improve the contact between the packaging unit and the laminated multi-layer. Finally, the product is released from the mould. Several post-drawing or post-moulding operations may optionally be performed in relation to the packaging unit. Preferably, the manufacturing method provides a relatively smooth outer surface (as compared to the inner surface). This improves possibilities for decoration, such as printing. Furthermore, this also improves denesting properties, including capsule release from the machine.

Several experiments have been performed with the illustrated packaging units. In several experiments an amount of a biodegradable aliphatic polyester was added to the moulded pulp material and a refining step was performed. Measurements were performed at a temperature of about 23° C. and a relative humidity of about 50%. Measurements involved a compression test. This showed a significant improvement in compression value. For example, a packaging unit with 7.5% PLA and/or PBS and/or PBST and/or PBAT and a refining step showed a compression value of 450 to 500 N, while for a similar conventional product under the same conditions this value is about 180 N. Even a sub-optimal conditions of relative humidity (RH) about 90% the compression value for the packaging unit according to the invention was about 250 to 270 N, thereby still outperforming the conventional product at its optimal conditions.

In a further test the multi-layer was applied to the food packaging unit with multi-layer 20 and for 24 hours exposed to 23° C. and a relative humidity of about 50%. No significant undesired oxygen penetration, referred to as the oxygen transfer rate (OTR), was detected. In fact, oxygen penetration was below 0.08 ml/m² day.

Further experiments in relation to the OTR were performed on several samples at a temperature of about 23° C. and a relative humidity of about 50%. Different multi-layers were tested. Samples in accordance with multi-layer 10 having one functional layer were tested having PBAT-PLA or PBAT cover layers and a GPolymer functional layer (thickness of 4 or 6 μm) and a total thickness of about 100 μm or about 120 μm, respectively. Also, samples in accordance with multi-layer 20 having two functional layers were tested having PBAT-PLA or PBAT cover layers and two GPolymer functional layers (thickness of 2×2 or 2×3 or 2×4 μm) and a total thickness of about 80 μm, about 100 μm, about 120 μm, or about 150 μm, respectively, and a (central) flexibility layer of a blend of biopolymers, such as PBS, PBAT and/or PBST. Also, as mentioned, these samples showed an OTR below 0.08 ml/m² d, and even below 0.05 ml/m² d, which was the lowest test limit in this experiment. These experiments confirmed an OTR below 1 ml/m² d, and even below 0.1 ml/m² d, is achieved. Optionally, the inner and outer cover layers are provided with different thicknesses.

In a further test pressure was increased to about 15 and about 20 bar. Multi-layers 10, 20 remained their integrity and barrier properties. This is relevant for coffee capsule 602, for example.

Further tests related to the water vapor transmission rate (WVTR). Several biofilms with multi-layer 10, 20 were tested. In Table 1 some experimental results are included. Tests were performed at a temperature of about 23° C. and a relative humidity of about 50%. In the table results are shown for two samples of the same composition.

TABLE 1
WVTR measurements

| | | measurement |
|---|---|---|
| Biofilm | measurement | type |
| PBS cover and GPolymer (thick) | below 3000 mg/m² d | Aquatran |
| PBS cover and GPolymer (thick) | below 3000 mg/m² d | Aquatran |
| PBS cover and GPolymer (thin) | 3000-3500 mg/m² d | Aquatran |
| PBS cover and GPolymer (thin) | 3000-3500 mg/m² d | Aquatran |
| PBAT-PLA cover and GPolymer | 2000-2500 mg/m² d | Aquatran |
| PBAT-PLA cover and GPolymer | 2000-2500 mg/m² d | Aquatran |
| Cover only: Blend PBAT and PLA | around 20 g/m² d | Permatran |
| | (indicative value)* | |
| Cover only Blend PBAT and PLA | around 20 g/m² d | Permatran |
| | (indicative value)* | |

Results show that water vapor transmission can be reduced significantly as compared to conventional materials that show water vapor transmission rates of up to 200 g/m² d. This shows that a biodegradable packaging unit can be applied to food products, including beverages and compounds for dispensing beverages such as tea, coffee, and soups. Also, at higher temperatures and pressures the transmission rate remains functional. Due to the fact that the functional layer of the biofilm is protected on both sides by a thin intermediate (tie) layer of PBAT (biopolyester) these layers avoid that the functional layer of GPolymer gets affected by water. This supports the good WVTR barrier properties of the entire film composition. This shows the applicability of the multi-layer for use in coffee capsules, for example. Furthermore, the low water vapor transmission rate that is achieved also reduces the loss of aroma due to a high WVTR. Also this is relevant for food packaging units, including coffee capsules.

Other tests related to other properties of the packaging unit, such as denesting. Providing an amount of 2 to 5 wt % of biodegradable aliphatic polyester in the moulded fiber matrix showed good denesting properties form a stack and/or external holder over a broad range of conditions, including a RH in the range of 50 to 90%, temperature of 23° C. to about 50° C., and pressures up to about 20 bar.

The present invention is by no means limited to the above described preferred embodiments thereof. The rights sought are defined by the following claims, within the scope of which many modifications can be envisaged.

1. A biodegradable packaging unit for a food product, the packaging unit comprising:
a container with an outer surface and an inner surface at least partly defining a compartment for holding the food product;
a biodegradable multi-layer that is provided on the inner surface of the container and comprising:
an inner cover layer comprising an amount of a biodegradable aliphatic polyester;
a first intermediate layer of a biodegradable material for connecting and/or sealing adjacent layers;
a functional layer comprising a polyvinylalcohol;
a second intermediate layer of a biodegradable material for connecting and/or sealing adjacent layers; and
an outer cover layer comprising an amount of a biodegradable aliphatic polyester,
wherein the container comprises a moulded fiber matrix with an amount of biodegradable aliphatic polyester.

2. The biodegradable packaging unit according to claim 1, wherein the amount of biodegradable aliphatic polyester in the moulded fiber matrix is in the range of 0.1 to 12 wt % of the unit.

3. The biodegradable packaging unit according to claim 1, wherein the biodegradable aliphatic polyester in the moulded fiber matrix comprises fibers.

4. The biodegradable packaging unit according to claim 3, wherein the fibers comprise PBS and/or PBST and/or PBAT.

5. The biodegradable packaging unit according to claim 1, wherein the amount of non-fiber based material is below 25 wt %, preferably below 20 wt %, and/or further comprising an amount of natural and/or alternative fibers.

6. The biodegradable packaging unit according to claim 1, wherein one or more of the intermediate layers of biodegradable material comprise a biodegradable aliphatic polyester.

7. The biodegradable packaging unit according to claim 1, further comprising a cover or lid for sealing the compartment, wherein the cover or lid comprises the biodegradable multi-layer comprising:
an inner cover layer comprising an amount of a biodegradable aliphatic polyester;
a first intermediate layer of a biodegradable material for connecting and/or sealing adjacent layers;
a functional layer comprising a polyvinylalcohol;
a second intermediate layer of a biodegradable material for connecting and/or sealing adjacent layers; and
an outer cover layer comprising an amount of a biodegradable aliphatic polyester.

8. The biodegradable packaging unit according to claim 7, wherein the cover or lid further comprising a paper layer.

9. The biodegradable packaging unit according to claim 8, wherein the cover or lid further comprising a second paper layer, and/or
wherein the paper layer comprises an opening for a window.

10. (canceled)

11. The biodegradable packaging unit according to claim 1, wherein the biodegradable multi-layer comprises at least two functional layers.

12. The biodegradable packaging unit according to claim 11, wherein the at least two biodegradable multi-layers are separated by a layer of a biodegradable aliphatic polyester.

13. The biodegradable packaging unit according to claim 1, wherein the thickness of the biodegradable multi-layer is in the range of 20 to 150 μm.

14. (canceled)

15. The biodegradable packaging unit according to claim 1, wherein the functional layer is positioned asymmetrically in the multi-layer.

16. The biodegradable packaging unit according to claim 1, wherein the laminated multi-layer comprises a colouring agent that is biodegradable and more preferably compostable.

17. (canceled)

18. The biodegradable packaging unit according to claim 1, wherein the matrix comprises an amount of calcium carbonate, wherein the matrix preferably comprises a mixture of micro fibrillated cellulose and calcium carbonate, preferably with an amount of 5 to 10 wt % of the matrix.

19. A method for manufacturing a biodegradable packaging unit for a food product, the method comprising the step of:
providing a container with an outer surface and an inner surface at least partly defining a compartment for holding the food product; and
providing a biodegradable multi-layer that is provided on the inner surface of the container and comprising:
an inner cover layer comprising an amount of a biodegradable aliphatic polyester;
a first intermediate layer of a biodegradable material for connecting and/or sealing adjacent layers;
a functional layer comprising a vinyl alcohol polymer;
a second intermediate layer of a biodegradable material for connecting and/or sealing adjacent layers; and
an outer cover layer comprising an amount of a biodegradable aliphatic polyester,
wherein the container comprises a moulded fiber matrix with an amount of biodegradable aliphatic polyester.

20. The method according to claim 19, wherein providing the biodegradable multi-layer comprises the step of co-extruding the layers, and/or
wherein the biodegradable laminated multi-layer is melted or fused with at least a part of the inner surface of the packaging unit.

21. (canceled)

22. The method according to claim 19, further comprising the step of providing a cover or lid, wherein the cover or lid comprises a biodegradable multi-layer comprising:
an inner cover layer comprising an amount of a biodegradable aliphatic polyester;
a first intermediate layer of a biodegradable material for connecting and/or sealing adjacent layers;
a functional layer comprising a polyvinylalcohol;
a second intermediate layer of a biodegradable material for connecting and/or sealing adjacent layers; and
an outer cover layer comprising an amount of a biodegradable aliphatic polyester.

23. The method according to claim 19, further comprising the step of performing (dry) sterilisation and pasteurisation of the packaging units, and/or
further comprising the step of biodegrading the packaging unit, and/or
further comprising the step of adding an amount of natural fibers.

24.-27. (canceled)

28. A biodegradable packaging unit for a food product, the packaging unit comprising:
a container with an outer surface and an inner surface at least partly defining a compartment for holding the food product; and
a biodegradable multi-layer that is provided on the inner surface of the container and comprising:
an inner cover layer comprising an amount of a biodegradable aliphatic polyester;
a first intermediate layer of a biodegradable material for connecting and/or sealing adjacent layers;
a functional layer comprising a polyvinylalcohol;
a second intermediate layer of a biodegradable material for connecting and/or sealing adjacent layers; and
an outer cover layer comprising an amount of a biodegradable aliphatic polyester,
wherein the container comprises a moulded fiber matrix with an amount of biodegradable aliphatic polyester, wherein the amount of biodegradable aliphatic polyester in the moulded fiber matrix is in the range of 0.1 to 12 wt % of the unit, and wherein one or more of the intermediate layers of biodegradable material comprise a biodegradable aliphatic polyester.
